(19) United States
(12) Patent Application Publication
(10) Pub. No.: US 2013/0227343 A1
(43) Pub. Date: Aug. 29, 2013

(54) Circuits and Methods for Replacing Defective Instructions

(71) Applicants: Xinsheng Peng, Wuhan (CN); Katsutoshi Akagi, Santa Clara, CA (US); Sheau-Chuen Her, San Jose, CA (US)

(72) Inventors: Xinsheng Peng, Wuhan (CN); Katsutoshi Akagi, Santa Clara, CA (US); Sheau-Chuen Her, San Jose, CA (US)

(73) Assignee: O2MICRO, INC., Santa Clara, CA (US)

(21) Appl. No.: 13/407,460

(22) Filed: Feb. 28, 2012

(51) Int. Cl. G06F 11/20; G06F 12/16

(52) U.S. Cl. 714/6.13; 711/162; 711/E12.103; 714/E11.087

(57) ABSTRACT

An address selector replaces an address pointing to a defective instruction in a built-in firmware. The address selector includes a comparing unit and a multiplexer. The comparing unit provides a comparison result by comparing a current address received from a processor with a predetermined address pointing to the defective instruction. The multiplexer coupled to the comparing unit receives a backup address pointing to a backup instruction, and the current address and if the current address matches the predetermined address, selects the backup address such that the current address is replaced by the backup address

### BACKGROUND

Many electronic devices are implemented with system-on-chip (SoC) and the SoC usually includes embedded firmware that cannot be modified. Ideally, the firmware should be error free, however, errors may be found as the SoC is used and tested. The firmware of the SoC can be replaced by “patch instructions” that may be stored in a random access memory (RAM), thus eliminating the costly process of redesigning the SoC.

A conventional method for patching firmware includes predicting defects that may exist in the firmware to predetermine backup codes that are used to patch the firmware. The firmware can be stored in a read-only memory (ROM), and the backup codes can be stored in a random access memory (RAM). In order to ensure that the backup codes patch all the defects that are uncovered later on, the backup codes may include unnecessary codes, such as backup codes for patching defects that may not exist, and may occupy a considerable large space in the RAM. Moreover, since the prediction result of the defects may not be exactly consistent with the execution result of the firmware, it is still possible that the backup codes cannot patch all the defects that appear in reality. Therefore, it is to a system that enables easy replacement of firmware the present application is primarily directed.

### SUMMARY

In one embodiment, the invention is an address selector that replaces an address pointing to a defective instruction in a built-in firmware. The address selector includes a comparing unit and a multiplexer. The comparing unit provides a comparison result by comparing a current address received from a processor with a predetermined address pointing to the defective instruction. The multiplexer coupled to the comparing unit receives a backup address pointing to a backup instruction, and the current address and if the current address matches the predetermined address, selects the backup address such that the current address is replaced by the backup address.

In another embodiment, the invention is a controller for replacing a set of defective instructions in a built-in firmware. The controller includes a non-rewritable memory, a backup memory, an address selector and a processor. The non-rewritable memory has multiple original instructions at multiple original addresses. The backup memory has a set of backup instructions at a set of backup addresses to patch the set of defective instructions in the multiple original instructions. The address selector coupled to the non-rewritable memory and the backup memory selects an execution address from a group of addresses by comparing a current address with a predetermined address that points to a defective instruction of the set of defective instructions and provides the set of backup addresses to replace a set of original addresses that point to the set of defective instructions with, wherein the group of addresses includes the multiple original addresses and the set of backup addresses. The processor coupled to the non-rewritable memory, the backup memory, and the address selector provides the current address to the address selector and executes an execution instruction stored at the execution address.

In yet another embodiment, the invention is a method for replacing a defective instruction in a built-in firmware that includes receiving, from a processor, a current address; providing the current address to an address selector; comparing, by the address selector, the current address with a predetermined address pointing to the defective instruction; if the current address matches the predetermined address, selecting a backup address that points to a backup instruction and replacing the current address with the backup address; retrieving the backup instruction stored at the backup address; and executing, by the processor, the backup instruction.

### BRIEF DESCRIPTION OF THE DRAWINGS

Features and advantages of embodiments of the claimed subject matter will become apparent as the following detailed description proceeds, and upon reference to the drawings, wherein like numerals depict like parts, and in which:

FIG. 1 shows an example of a block diagram of an electronic system, in accordance with one embodiment of the present invention.

FIG. 2 shows an example of a block diagram of a controller, in accordance with one embodiment of the present invention.

FIG. 3 shows an example of a block diagram of an address selector, in accordance with one embodiment of the present invention.

FIG. 4 shows a flowchart of an example of a method for replacing a defective instruction in a built-in firmware, in accordance with one embodiment of the present invention.

### DETAILED DESCRIPTION

Reference will now be made in detail to the embodiments of the present invention. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

Embodiments in accordance with the present invention provide circuits and methods for replacing defective instructions of a firmware. The firmware stored in a non-rewritable memory may have defects that may not be detected during pre-employment testing. However, these hidden defects may become visible as the firmware is thoroughly executed. To fix these defects that are discovered later, the patch instructions can be stored in a backup memory and these patch instructions will be executed later by the processor in lieu of the defective instructions. Advantageously, since the patch instructions stored in the backup memory are devised after detection of the defects, the patch instructions stored in the backup memory can patch the firmware efficiently and completely. Moreover, since the patch instructions stored in the backup memory do not include unnecessary codes, space of the backup memory can be saved.

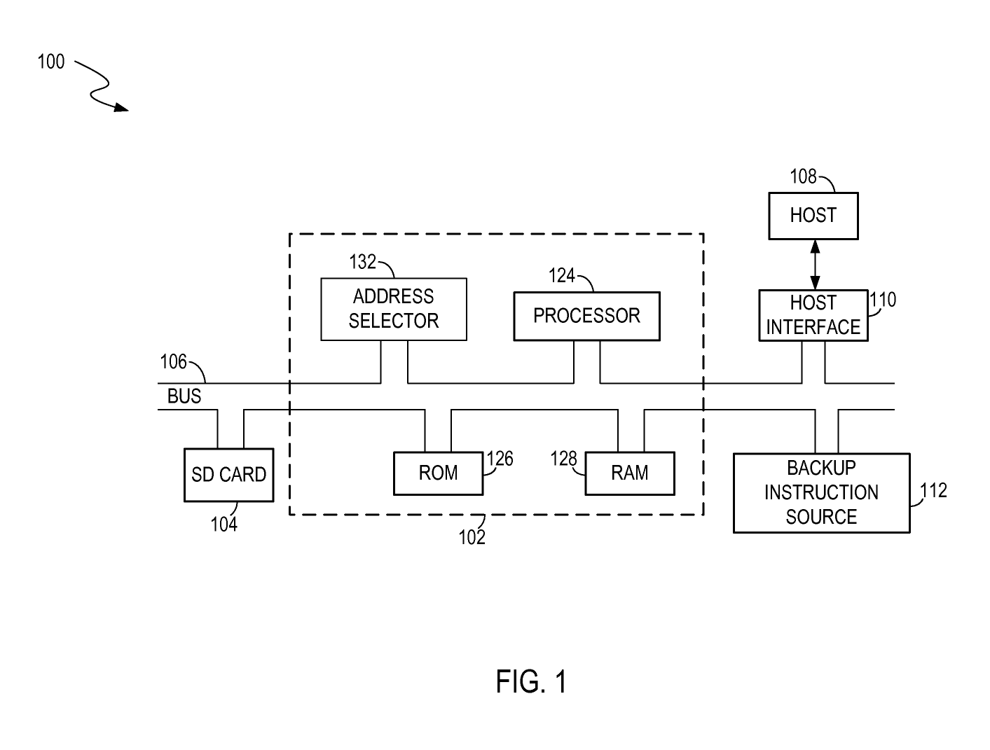

FIG. 1 shows an example of a block diagram of an electronic system 100, in accordance with one embodiment of the present invention. The system 100 includes a communication bus 106, a host 108, a host interface 110, a memory card, such as a secure digital (SD) card 104, a controller 102 and a backup instruction source 112. The host 108 can be, but is not limited to, a computer or camera. The host interface 110 can be a logic circuit for the host 108 to communicate with other subsystems, such as the controller 102, the SD card 104 and so on, via the bus 106. The host 108 can access the SD card 104, e.g., read data from the SD card 104 or write data into the SD card 104, under the control of the controller 102.

The controller 102 can be, but not necessarily, used in a digital camera application shown in FIG. 1. For example, the host 108 is a central processor unit in the digital camera, and the controller 102 is a card reader integrated in the digital camera. The digital camera accesses an SD card, e.g., reads data from the SD card or writes data to the SD card, via the card reader.

More specifically, in operation, the host 108 sends a command, e.g., a command instructing the controller 102 to read data from the SD card 104, to the controller 102 via the host interface 110. The controller 102 receives the command, and executes instructions stored in the controller 102 accordingly so as to fetch data from the SD card 104 and sends the fetched data to the host 108. The host 108, the host interface 110, the SD card 104 and the controller 102 communicate via the bus 106.

In the example of FIG. 1, the controller 102 includes a processor 124, an address selector 132, a non-rewritable memory such as a read-only memory (ROM) 126, and a backup memory 128. In one embodiment, the backup memory 128 is a rewritable memory such as a random access memory (RAM). The ROM 126 stores a set of original instructions as a built-in firmware, at a set of original addresses ADD_O. The RAM 128 stores a set of backup instructions at a set of backup addresses ADD_B. The RAM 128 may store other data or instructions for the electronic system 100.

In operation, when an engineer tests the controller 102 or an end user uses a system that includes the controller 102, the processor 102 receives commands from the host 108 and performs functions accordingly. In one instance, the processor 124 receives a command from the host 108 and performs a function corresponding to the command by executing the set of original instructions. In another instance, the processor 124 receives a command from the host 108 and performs a function not corresponding to the command, e.g., performs an undesired function, by executing the set of original instructions. In the second instance, the set of original instructions may have defects. To achieve the function corresponding to the command, the processor 124 can execute the set of backup instructions instead of defective instructions of the set of original instructions.

In the above example, the set of backup instructions stored in the RAM 128 are used to patch defective instructions of the set of original instructions stored in the ROM 126. More specifically, the processor 124 executes the set of original instructions initially. The result of executing shows the set of original instructions have defects. Therefore, after the processor 124 has executed the set of the original instructions, the set of backup instructions can be determined according to the defective instructions, e.g., devised to fix the defective instructions, and can be stored at the set of backup addresses ADD_B in the RAM 128. In one embodiment, the set of backup instructions are stored in the backup instruction source 112, and the backup instructions are loaded from an external source, such as a website or a server. For electronic devices in use by consumers (or end-users) and have defective instructions, the consumers can obtain the set of backup instructions from manufacturers of the electronic devices. The processor 124 downloads the set of backup instructions from the backup instruction source 112 and stores the set of backup instructions in the RAM 128. In another embodiment, the set of backup instructions are stored in an external storage unit, and the backup instruction source 112 is an interface to an external source. The processor 124 downloads the set of backup instructions from the external storage unit that stores the set of backup instructions via the interface, and the processor 124 then stores the set of backup instructions at the set of backup addresses ADD_B in the RAM 128. In another embodiment, the end users or the engineers stores the set of backup instructions in the host 108, and the host 108 stores the set of backup instructions in the RAM 128.

The address selector 132 selects an address from a group of addresses ADD_G. The group of addresses ADD_G includes the set of original addresses ADD_O pointing to the original instructions stored in the ROM 126 and the set of backup addresses ADD_B pointing to the backup instructions stored in the RAM 128. The processor 124 provides a current address to the address selector 132, and the address selector 132 selects an address according to the current address, and the processor 124 executes the instruction stored at the address selected by the address selector 132.

In one embodiment, if the processor 124 provides an original address from the set of original addresses to the address selector 132, and the original address points to an original instruction having no defects, the address selector 132 selects the original address provided by the processor 124, and the processor 124 executes the original instruction stored at the original address provided by the processor 124. In another embodiment, after the backup instructions have been stored in the RAM 128 and the address selector 132 adjusted accordingly, if the processor 124 provides an original address of the set of original addresses to the address selector 132, and the original address points to an original instruction having defects, the address selector 132 selects a backup address corresponding to the original address provided by the processor 124, and the processor 124 executes a corresponding backup instruction stored at the backup address selected by the address selector 132. The processor 124, the address selector 132, the ROM 126 and the RAM 128 communicate via the bus 106.

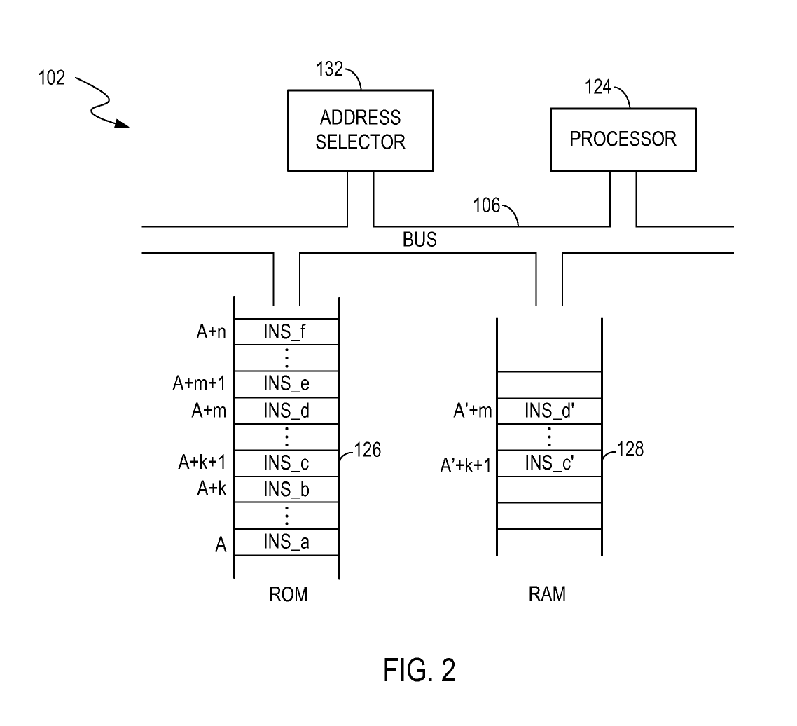

FIG. 2 is an example of the controller 102 that has defective instructions and also has backup instructions installed. In the example of FIG. 2, original instructions, e.g., labeled INS_a, . . . , INS_b, INS_c, . . . , INS_d, INS_e, . . . , INS_f, are stored respectively at the addresses A to A+n in the ROM 126 (n=1, 2, . . . ). The original instructions INS_c to INS_d are deemed to be defective based on a previous execution of the original instructions. The original instructions INS_c to INS_d are patched by having the processor 124 execute backup instructions INS_c′ to INS_d′ instead of defective instructions INS_c to INS_d. In other words, the processor 124 can perform a correct function by executing the instructions INS_a to INS_b, INS_c′ to INS_d′ and INS_e to INS_f, in sequence. The patching instructions INS_c′ to INS_d′ are stored in the RAM 128, and can have corresponding addresses A′+k+1 to A′+m respectively (k=1, 2, . . . ; m=k+2, k+3, . . . ). Furthermore, the address selector 132 selects addresses in a way such that the processor 124 executes the set of backup instructions INS_c′ to INS_d′ and the original instructions INS_a to INS_f except the defective instructions INS_c to INS_d. In other words, the address selector 132 selects the addresses A to A+k, A′+k+1 to A′+m, and A+m+1 to A+n in sequence, and the processor 124 executes the instructions INS_a to INS_b, INS_c′ to INS_d′ and INS_e to INS_f in sequence accordingly.

More specifically, a predetermined address A_{PRE} is determined by an address of the defective instructions. In one embodiment, the predetermined address A_{PRE} is the address pointing to the defective instructions to be replaced by the backup instructions. For example, the predetermined address A_{PRE} is the address pointing to the first instruction of a block of instructions that includes the defective instructions such as a beginning address A+k+1 of the defective instructions INS_c to INS_d. The address selector 132 selects an execution address from a group of addresses ADD_G by comparing a current address ADD_C provided by the processor 124 with the predetermined address A_{PRE}. The “current address” as used herein means the address pointing to an instruction to be executed by a processor at a current/present moment, in one embodiment. The “current address” can be an initial address of a set of addresses pointing to a set of instructions when the controller 102 is powered. Moreover, the “current address” can be an address following a previous address that points to an instruction executed in the previous moment. Furthermore, the “current address” can be set by an instruction. By way of example, the group of addresses ADD_G includes the addresses A to A+n and A′+k+1 to A′+m. In one embodiment, if the current address ADD_C matches the predetermined address A+k+1, the address selector 132 selects a backup address such as the address A′+k+1 corresponding to the predetermined address A+k+1. The backup address A′+k+1 is the beginning address of the set of backup addresses A′+k+1 to A′+m. The address A+k+1 points to the instruction INS_c, and the address A′+k+1 points to the instruction INS_c′. The instruction INS_c′ is corresponding to the instruction INS_c. Thus, if the current address ADD_C matches the predetermined address A+k+1, the processor 124 accordingly executes the instruction INS_c′ instead of the instruction INS_c. If the current address ADD_C mismatches the predetermined address A+k+1, the address selector 132 selects the current address ADD_C.

In operation, in one scenario, the current address ADD_C is equal to A. The address selector 132 compares the current address ADD_C with the predetermined address A+k+1. Since the current address ADD_C is different from the predetermined address A+k+1, the address selector 132 selects the current address ADD_C which is equal to A. After the processor 124 executes the instruction INS_a at the address A, the current address ADD_C is changed to A+1. Similarly, the address selector 132 selects the address A+1 since the address A+1 mismatches the predetermined address A+k+1. In the following process, the address selector 132 selects the addresses A+2 to A+k in a similar manner.

When the current address ADD_C is equal to A+k+1, since the current address ADD_C is the same as the predetermined address A+k+1, the address selector 132 selects the corresponding backup address A′+k+1 of the RAM 128. In one scenario, the instruction INS_c′ at the address A′+k+1 instructs the processor 124 to set the current address to be A′+k+2. Therefore, after the processor 124 executes the instruction INS_c′, the current address ADD_C is changed to A′+k+2. Since the current address ADD_C is different from the predetermined address A+k+1, the address selector 132 selects the address A′+k+2. In the following process, the address selector 132 selects the addresses A′+k+2 to A′+m in a similar manner.

In one embodiment, the instruction INS_d′ at the address A′+m instructs the processor 124 to set the current address ADD_C to be A+m+1. Since the current address ADD_C is different from the predetermined address A+k+1, the address selector 132 selects the address A+m+1, and the processor 124 executes the original instruction INS_e at the address A+m+1.

In another embodiment, the execution result of executing the original instructions INS_a to INS_f indicates that only original instruction INS_c has defects. The original instruction INS_c can be patched by having the processor 124 execute the backup instruction INS_c′ instead of the defective instruction INS_c. Therefore, the predetermined address A_{PRE} is set to be A+k+1. When the current address ADD_C is equal to A+k+1, since the current address ADD_C is the same as the predetermined address A+k+1, the address selector 132 selects the corresponding backup address A′+k+1 of the RAM 128. The instruction INS_c′ at the address A′+k+1 does not instruct the processor 124 to set the current address to be an address in the RAM 128. Therefore, after the processor 124 executes the instruction INS_c′, the current address ADD_C is the address A+k+2 following the previous current address A+k+1. Since the current address ADD_C is different from the predetermined address A+k+1, the address selector 132 selects the address A+k+2. In the following process, the address selector 132 selects the addresses A+k+3 to A+m in a similar manner.

In other words, the address selector 132 selects the execution address from a group of addresses ADD_G by comparing a current address ADD_C provided by the processor 124 with a predetermined address A_{PRE}. The execution address points to an execution instruction to be executed by the processor 124. The group of addresses ADD_G includes a set of original addresses (e.g., A to A+n) and a set of backup addresses (e.g., A′+K+1 to A′+m). The set of original addresses point to a set of original instructions (e.g., INS_a to INS_f) stored in the non-rewritable memory 126. The set of backup addresses point to a set of backup instructions (e.g., INS_c′ to INS_d′) stored in the backup memory 128. The set of backup instructions (e.g., INS_c′ to INS_d′) patch defective instructions (e.g., INS_c to INS_d) of the set of original instructions (e.g., INS_a to INS_f). The predetermined address A_{PRE} (e.g., A+k+1) points to a defective instruction (e.g., INS_c). As such, the address selector 132 can replace a set of original addresses (e.g., A+k+1 to A+m) pointing to the defective instructions with the set of backup addresses. Moreover, the set of backup instructions and the predetermined address are determined according to the execution result of the set of original instructions executed by the processor 124.

Advantageously, since the backup instructions are devised according to the execution result of the original instructions of the firmware rather than a predicting result of the defects of the firmware, the backup instructions can adequately and effectively patch the defective instructions stored in firmware. Moreover, the RAM can, but not necessarily, include only the backup instructions that patch the defective instructions detected by the processor 124 rather than a great number of backup instructions that patch all possible defective instructions predicted. Thus, space of the RAM can be saved.

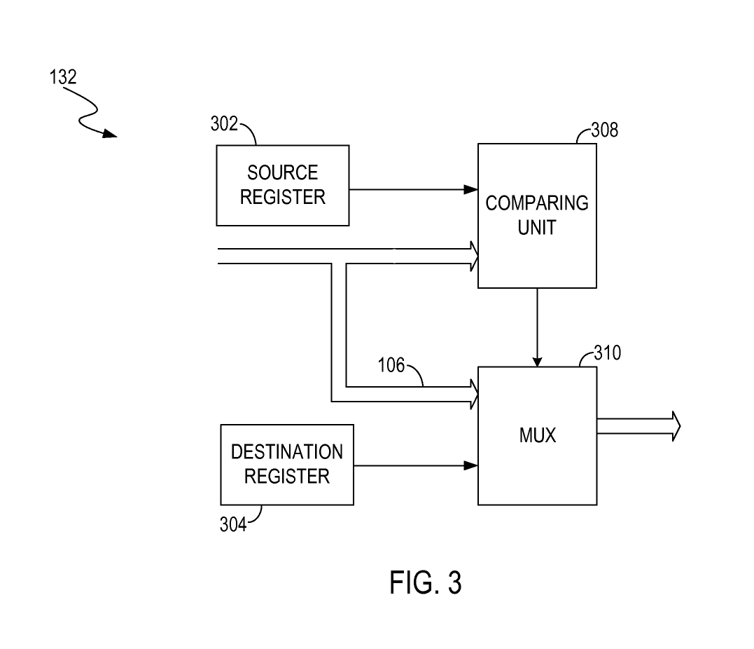

FIG. 3 shows an example of a block diagram of the address selector 132 shown in FIG. 2, in accordance with one embodiment of the present invention. In the example of FIG. 3, the address selector 132 includes a source storage unit such as a source register 302, a destination storage unit such as a destination register 304, a comparing unit 308, and a multiplexer 310.

After the defects of the set of original instructions are detected, the information of a predetermined address A_{PRE} such as the address A+k+1 mentioned above and a backup address, e.g., a beginning address, of a set of backup addresses are provided to the processor 124, via the backup instruction source 112 or the host 108. For the end users, the information is provided as part of a fix-pack by the manufacturer of the controller. The processor 124 stores the predetermined address A_{PRE} in the source register 302, and stores the backup address in the destination register 304. The backup address stored in the destination register 304 corresponds to the predetermined address A_{PRE}, and can be a beginning backup address of the set of backup addresses. For example, the backup address stored in the destination register 304 is equal to A′+k+1 as mentioned above. The processor 124 sends a current address ADD_C to the comparing unit 308 and the multiplexer 310 via the bus 106. The comparing unit 308 provides a comparison result by comparing the current address ADD_C with the predetermined address A_{PRE} (e.g., A+k+1). The comparison result indicates whether the current address ADD_C matches the predetermined address A_{PRE}. The multiplexer 310 receives the current address ADD_C and the backup address A′+k+1, and selects an address from the current address ADD_C and the backup address A′+k+1 according to the comparison result of the comparing unit 308.

In one embodiment, the multiplexer 310 selects the backup address A′+k+1 if the current address ADD_C matches the predetermined address A_{PRE} so as to replace the current address ADD_C with the backup address A′+k+1, and the multiplexer 310 selects the current address ADD_C and the processor 124 executes an original instruction stored at the current address ADD_C if the current address ADD_C does not match the predetermined address A_{PRE}. The processor 124 executes an instruction stored at the selected address.

In the example of FIG. 3, the address selector 132 includes a source register 302 and a destination register 304 for illustration purposes but not intended for limitation. The address selector 132 can include multiple source registers and destination registers. In one embodiment, the ROM 126 in FIG. 2 includes multiple sets of defective instructions to be patched by multiple sets of corresponding backup instructions. In one such embodiment, the first address, e.g., the beginning address, of each set of defective instructions can be used as a predetermined address to be compared with the current address. For example, the ROM 126 includes an instruction set AS₁, an instruction set AS₂, and an instruction set AS₃ to be patched. Accordingly, the RAM 128 includes an instruction set AS′₁, an instruction set AS′₂, and an instruction set AS′₃ to patch the instruction set AS₁, the instruction set AS₂, and the instruction set AS₃ respectively. Each instruction set of the instruction sets AS₁-AS₃ and AS′₁-AS′₃ have one or more instructions. In one such embodiment, three source registers store a predetermined address A_{PRE1}, a predetermined address A_{PRE2}, and a predetermined address A_{PRE3}. Three destination registers store the beginning address of instruction set AS′₁, the beginning address of instruction set AS′₂, and the beginning address of instruction set AS′₃. The comparing unit 308 compares the current address ADD_C with the predetermined addresses A_{PRE1}-A_{PRE3}, and the multiplexer 310 selects an address from the current address ADD_C and the beginning addresses of instruction sets AS′₁-AS′₃ according to a comparison result of the comparing unit 308. For example, if the current address ADD_C matches the predetermined addresses A_{PRE2}, the multiplexer 310 selects the beginning address of instruction set AS′₂.

In an alternative embodiment, a source register can store the predetermined address A_{PRE1}, and a destination address can store the beginning address of instruction set AS′₁ at initially. After the processor 124 has executed the instruction set AS′₁ instead of the instruction set AS₁, the source register can store the predetermined address A_{PRE2}, and the destination address can store the beginning address of instruction set AS′₂. After the processor 124 has executed the instruction set AS′₂ instead of the instruction set AS₂, the source register can store the predetermined address A_{PRE3}, and the destination address can store the beginning address of instruction set AS′₃. In this embodiment, only one source register and one destination register are needed to patch multiple sets of defective instructions.

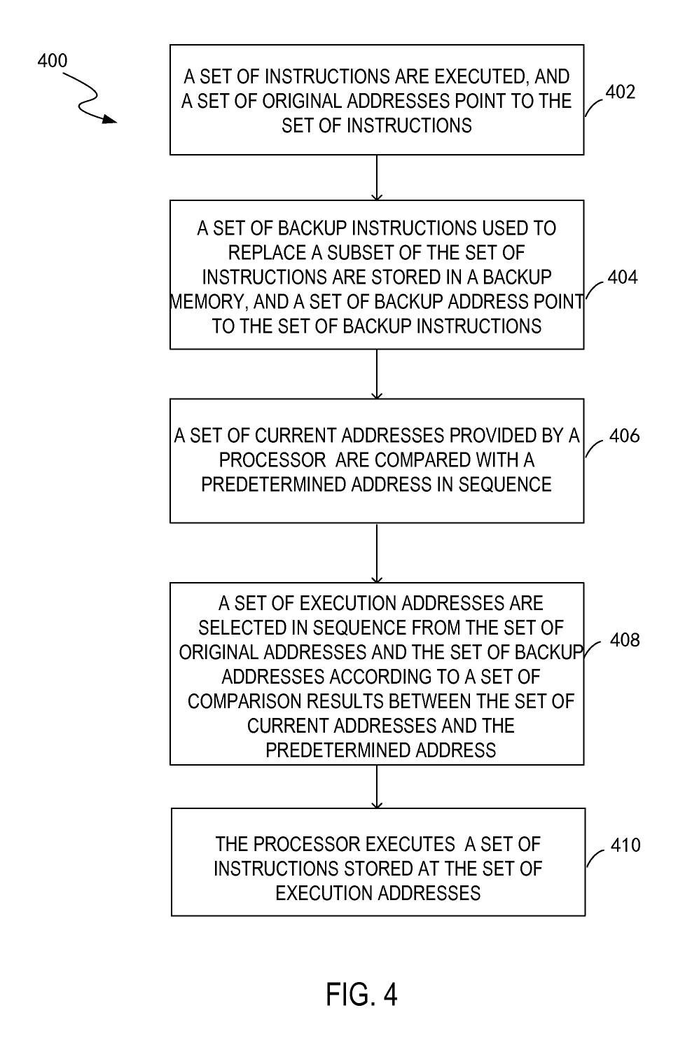

FIG. 4 shows a flowchart 400 of an example of a method for replacing a set of defective instructions in a built-in firmware, in accordance with one embodiment of the present invention. FIG. 4 is described in combination with FIG. 1, FIG. 2 and FIG. 3.

In block 402, a set of original instructions such as the aforementioned instructions INS_a to INS_f are executed by a processor 124, e.g., thereby detecting a defect of the original instructions. A set of original addresses such as the aforementioned addresses A to A+n point to the set of original instructions. The set of original instructions are stored in a non-rewritable memory.

In block 404, a set of backup instructions, used to replace a set of defective instructions of the set of original instructions, are downloaded from a storage unit or the host 108, e.g., by the processor 124 or the host 108. The set of backup instructions are further stored in a backup memory, e.g., by the processor 124. A set of backup addresses point to the set of backup instructions.

In block 406, a set of current addresses received from the processor 124 are provided to an address selector 132 in sequence, and the current addresses are compared with a predetermined address by the address selector 132 in sequence. In one embodiment, the predetermined address points to a defective instruction of the set of defective instructions.

In block 408, a set of execution addresses are selected in sequence, using the address selector 132, from a group of addresses according to a set of comparison results between the current addresses and the predetermined address. The group of addresses includes the set of original addresses and the set of backup addresses. In one embodiment, a current address of the set of current addresses is selected as an execution address if the current address does not match the predetermined address, and a backup address corresponding to the predetermined address is selected as the execution address if the current address matches the predetermined address.

In block 410, a set of instructions stored at the set of execution addresses are retrieved and executed, e.g., by the processor 124. If the current address matches the predetermined address, the execution address points to a backup instruction and the processor 124 executes the backup instruction instead of a defective instruction stored at the current address, and desired the execution result is produced. If the current address mismatches the predetermined address, an original instruction stored at the current address is executed by the processor 124.

While the foregoing description and drawings represent embodiments of the present invention, it will be understood that various additions, modifications and substitutions may be made therein without departing from the spirit and scope of the principles of the present invention as defined in the accompanying claims. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being indicated by the appended claims and their legal equivalents, and not limited to the foregoing description.

What is claimed is:

1. An address selector, for replacing an address pointing to a defective instruction in a built-in firmware, comprising:
a comparing unit that provides a comparison result by comparing a current address received from a processor with a predetermined address pointing to the defective instruction; and
a multiplexer, coupled to the comparing unit, that receives a backup address pointing to a backup instruction and the current address, and if the current address matches the predetermined address, selects the backup address such that the current address is replaced by the backup address.

2. The address selector of claim 1, wherein the multiplexer selects the current address if the current address mismatches the predetermined address.

3. The address selector of claim 1, further comprising:
a first storage unit, coupled to the comparing unit, for storing the predetermined address; and
a second storage unit, coupled to the multiplexer for storing the backup address.

4. The address selector of claim 1, wherein the backup instruction is stored in a rewritable memory.

5. The address selector of claim 1, wherein the backup instruction is stored at the backup address by the processor after the processor executes the defective instruction.

6. A controller for replacing a set of defective instructions in a built-in firmware, comprising:
a non-rewritable memory having a plurality of original instructions at a plurality of original addresses;
a backup memory having a set of backup instructions at a set of backup addresses to patch the defective instructions;
an address selector, coupled to the non-rewritable memory and the backup memory, for selecting an execution address from a group of addresses by comparing a current address with a predetermined address that points to a defective instruction, and for providing the backup addresses to replace a set of original addresses that point to the defective instructions, wherein the group of addresses comprises the original addresses and the backup addresses; and
a processor, coupled to the non-rewritable memory, the backup memory, and the address selector, for providing the current address to the address selector and for executing an execution instruction stored at the execution address.

7. The controller of claim 6, wherein the processor executes the backup instructions instead of the defective instructions if the current address matches the predetermined address.

8. The controller of claim 6, wherein the address selector comprises:
a first register that stores the predetermined address;
a second register that stores a beginning backup address of the backup addresses;
a comparing unit, coupled to the first register, that provides a comparison result indicating whether the current address matches the predetermined address by comparing the current address with the predetermined address; and
a multiplexer, coupled to the second register and the comparing unit, that selects the current address as the execution address if the current address mismatches the predetermined address, and selects the beginning backup address as the execution address if the current address matches the predetermined address.

9. The controller of claim 6, wherein the predetermined address and the backup instructions are determined according to an execution result of executing the original instructions.

10. The controller of claim 6, wherein the predetermined address points to the first instruction of the defective instructions.

11. The controller of claim 10, wherein an instruction stored at the beginning address of the backup addresses, when executed by the processor, causes the processor to change the current address to a next address next to the beginning address.

12. The controller of claim 11, wherein the address selector further selects a next execution address by comparing the current address that is changed to the next address with the predetermined address, and wherein the processor executes an instruction stored at the next execution address.

13. The controller of claim 6, wherein the backup memory comprises a rewritable memory.

14. The controller of claim 6, wherein the processor stores the backup instructions at the backup addresses after the processor executes the original instructions.

15. A method for replacing a defective instruction in a built-in firmware, comprising:
receiving, from a processor, a current address;
providing the current address to an address selector;
comparing, by the address selector, the current address with a predetermined address pointing to the defective instruction;
if the current address matches the predetermined address, selecting a backup address that points to a backup instruction and replacing the current address with the backup address;
retrieving the backup instruction stored at the backup address; and
executing, by the processor, the backup instruction.

16. The method of claim 15, further comprising:
if the current address mismatches the predetermined address, retrieving an original instruction stored at the current address; and
executing, by the processor, the original instruction.

17. The method of claim 15, further comprising:
storing the backup instruction in a rewritable memory after the processor executes the defective instruction.

18. The method of claim 15, further comprising:
executing the backup instruction instead of the defective instruction, by the processor, if the current address matches the predetermined address.
